(19) United States
(12) Patent Application Publication
(10) Pub. No.: US 2026/0180391 A1
(43) Pub. Date: Jun. 25, 2026

(54) STATOR OF AN ELECTRIC MACHINE

(71) Applicant: Robert Bosch GmbH, Stuttgart (DE)

(72) Inventors: Jannik Stammler, Stuttgart (DE); Andreas Herzberger, Remseck Am Neckar (DE); Felix Bensing, Stuttgart (DE); Claus-Christian Oetting, Blaichach (DE); Lea Jaeger, Pattensen (DE)

(21) Appl. No.: 19/125,137

(22) PCT Filed: Oct. 4, 2023
(86) PCT No.: PCT/EP2023/077387

§ 371 Date: Apr. 28, 2025

(30) Foreign Application Priority Data
Oct. 28, 2022 (DE) 10 2022 211 492.2

(51) Int. Cl. H02K 5/20

(52) U.S. Cl. CPC H02K 5/203

(57) ABSTRACT

The invention relates to a stator (1) of an electric machine (2) having a stator laminated core (5) on which stator slots (7) are formed, wherein a conductor bundle (10) for forming an electrical stator winding (11) is provided in each of the stator slots (7), wherein slot gaps (12) are formed between flanks (7f) of the respective stator slot (7) and the respective conductor bundle (10), which form a slot gap channel (13) in the respective stator slot (7), through which slot gap channel a cooling medium can flow along a slot cooling path (14), wherein the stator slots (7) each extend in the radial direction between a slot base (7g) and a slot slit (7s), wherein the slot slits (7s) are closed by a status sealing sleeve (15), wherein the status sealing sleeve (15) has radial projections (16) on an outer side, which extend into the slot slits (7s) in the radial direction, characterized in that—the radial projections (16) of the static sealing sleeve (15) are slot slit obstructions that block or constrict portions of the respective slot slit (7s) for the slot cooling path (14),—a plurality of slot slit obstructions (16) are formed on the stator sealing sleeve (15) per slot slit (7s),—a slot slit passage (17) is formed between adjacent slot slit obstructions (16) of the same slot slit (7s), and—the slot slit obstructions (16) are bead-shaped.

### BACKGROUND

The invention proceeds from a stator.

A stator of an electric machine is already known from DE102020126408 A1 and DE102020119110 A1, having a stator axis and a stator laminated core on which stator teeth and stator slots lying between the stator teeth are formed and which comprises a plurality of laminations, wherein a conductor bundle comprising an individual conductor or multiple conductors, in particular a stack of flat wire conductors, is provided to form an electric stator winding in the stator slots, wherein slot gaps are formed between flanks of the respective stator slot and the conductor or conductor bundle arranged in the stator slot, which form a slot gap channel extending in the axial direction with respect to the stator axis in the respective stator slot, through which slot gap channel a cooling medium, in particular oil, can flow along a slot cooling path, wherein the stator slots each extend in the radial direction with respect to the stator axis between a slot base and a slot slit, wherein the slot slits of the stator slots are closed by a slot closure formed as a stator sealing sleeve, wherein the stator sealing sleeve comprises radial projections on an outer side facing away from the stator laminations extending in the radial direction in the slot slit and extend in the axial direction. The stator sealing sleeve comprises stiffening ribs for pressing the stator sealing sleeve onto the inner diameter of the stator. The stiffening ribs are formed continuously in the axial direction.

### SUMMARY

In contrast, the stator according to the invention has the advantage that the stator sealing sleeve contributes to the adjustment of a meandering slot cooling path and, due to the improved flow guide, improves cooling of the stator. In particular, the conductor bundle is more evenly cooled in the respective slot gap channel along the cooling path.

This is achieved according to the present invention in that
the radial projections of the stator sealing sleeve are slot slit obstructions that block or constrict the portions of the respective slot slit for the slot cooling path, and
a plurality of spaced apart slot slit obstructions are formed in the axial direction with respect to the stator axis on the stator sealing sleeve per slot slit of the stator, which extend in particular to the conductor or the conductor bundle,
a slot slit passage for deflecting the slot cooling path is formed between adjacent slot slit obstructions of the same slot slit
the slot slit obstructions of the stator sealing sleeve are bead-shaped.

The bead-shaped slot-slit obstructions allow an inexpensive production of the stator sealing sleeve according to the invention.

According to an advantageous embodiment, the slot slit passages of the stator sealing sleeve can be configured as a bead interruption or as a bead with reduced bead height.

It is particularly advantageous if the stator sealing sleeve per slot slit has an obstruction pattern comprising at least one slot slit obstruction and at least one slot slit passage, wherein a first obstruction pattern is provided for a first set of slot slits and a second obstruction pattern is provided for a second set of slot slits, wherein the second obstruction pattern has a slot slit obstruction at axial positions, on which the first obstruction pattern comprises a slot slit passage, wherein the slot slit obstructions of both obstruction patterns overlap in particular when viewed in the axial direction. In this way, the bypasses are arranged in a first set of stator slots arranged radially opposite from a second set of stator slots, such that the meandering slot cooling paths in the first set of stator slots extend radially opposite the second set of stator slots. Thus, at axial positions where a bypass in the slot base is formed in the first set of stator slots, a bypass in the slot slit is provided in the second set of stator slots.

It is further advantageous if a plurality of support points spaced apart from one another in the axial direction with respect to the stator axis are formed in each of the stator slots for supporting the conductor or conductor bundle lying in the respective stator slot, wherein the respective slot cooling path is at least constricted at the support locations, wherein a bypass is provided at each of the support points to guide the cooling medium past the respective constricted support point, wherein the bypasses of the respective stator slot for forming a meandering slot cooling path along the axial extension of the respective stator slot are formed alternately at the slot base or in the slot slit, wherein the bypass in the slot slit is provided as the slot slit passage on the stator sealing sleeve. In this way, the flow can pass through the slot gap channels continuously, wherein the bypasses lying in the slot slit are formed as a slot slit passage on the stator sealing sleeve. Slot slit obstructions are formed in the slot slits between the support points to avoid a straight flow through the slot slit that is disadvantageous for cooling.

It is very advantageous if the support points are formed by rotating at least two laminations of the laminated core about the stator axis by a specific angular rotation. In this way, the support points can be manufactured particularly simply. In particular, this solution does not require special lamellas in the stator laminated core.

It is also advantageous if the stator sealing sleeve is fixedly connected to the stator by forming, in particular hot working, in particular by displacing material of the stator sealing sleeve into the slot slits. In this way, a very thin stator sealing sleeve can be achieved that only slightly increases the air gap of the electric machine so that a high output of the electric machine can continue to be achieved. In addition, the sealing of the slot slits is improved by the material displacement.

Furthermore, it is advantageous when the stator sealing sleeve is made of a material comprising a thermoplastic, in particular a thermoplastic composite, specifically a fiber-reinforced composite. In this way, the production of the stator sealing sleeve is enabled by a hot working process.

In addition, it is advantageous if the stator sealing sleeve is made of a blank to be formed, wherein the blank is a smooth tube, in particular an extruded sleeve, which is mounted to the stator laminated core with the joining air and is subsequently expanded. Alternatively, the blank may be a strip of flat material, in particular from an organic sheet, which is formed on circumferential sides of the stator teeth facing the air gap to achieve the sleeve shape, in particular with overlapping of the two ends of the strip of flat material, and is formed into the slot slits of the stator laminated core, in the area of the slot slits, in particular by rolling burnishing. In this way, an inexpensive production of the stator sealing sleeve for large-scale production is achieved.

Furthermore, the invention relates to a method for forming a stator sealing sleeve on a stator of an electric machine, the method comprising the steps of:
a. providing a finished stator comprising a stator laminated core and a stator winding,
b. arranging a blank for generating a stator sealing sleeve along circumferential sides of the stator teeth of the stator laminated core facing the air gap,
c. generating the stator sealing sleeve by forming, in particular hot forming, the blank, in particular by roller burnishing or expanding, by means of at least one forming tool such that the blank lies against the circumferential sides of the stator teeth facing the air gap, in particular such that material of the blank is forced into the slot slits,
d. generating beads in the stator sealing sleeve to form the slot slit obstructions.

The method has the advantage that pressing the stator sealing sleeve is omitted. The stator sealing sleeve does not have to be highly stiff to enable the pressing. Instead, a blank is rigidly formed onto the stator by forming.

The invention also relates to an electrical machine with a stator according to the invention.

### BRIEF DESCRIPTION OF THE DRAWINGS

An exemplary embodiment of the invention is shown in simplified form in the drawing and explained in more detail in the following description.

Shown are:

FIG. 1 shows an electric machine with a stator according to the invention and a rotor in section,

FIG. 2 shows a section through one of the stator slots of the stator along a line A-A in FIG. 1,

FIG. 3 shows a section through one of the stator slots of the stator along a line B-B in FIG. 1,

FIG. 4 shows a section through one of the stator slots of the stator along a line C-C in FIG. 1, and

FIG. 5 shows a sectional view on an inner circumference of the stator according to FIG. 1 with the stator sealing sleeve according to the invention abutting the inner circumference.

### DETAILED DESCRIPTION

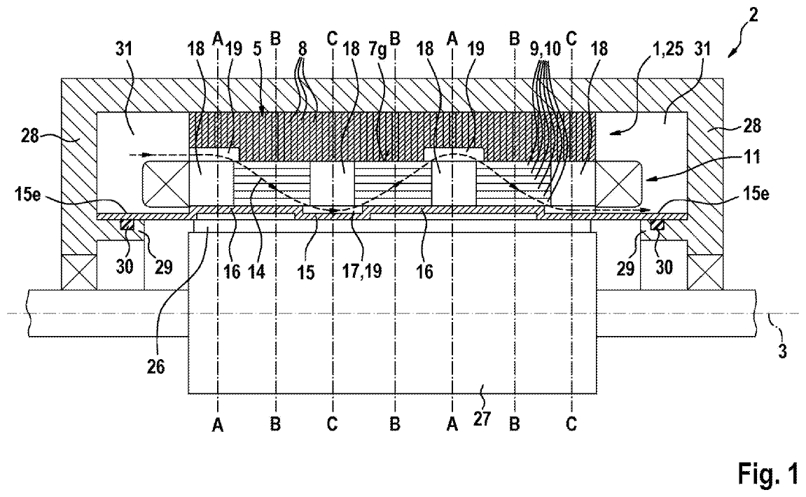

FIG. 1 shows an electric machine with a stator according to the invention and a rotor in section.

The stator 1 of the electric machine 2 has a stator axis 3 and comprises a stator laminated core 5 on which the stator teeth 6 and stator slots 7 lying between the stator teeth 6 are formed and which comprises a plurality of laminations 8. A conductor bundle 10 comprising an individual electrical conductor 9 or a plurality of conductors 9, in particular a stack of flat wire conductors, is provided in each of the stator slots 7 to form an electric stator winding 11. The individual electrical conductor 9 is an enameled wire, for example. Slot gaps 12 are formed between the flanks 7f of the respective stator slot 7 and the conductor 9 or conductor bundle 10 arranged in the stator slot 7, which form a slot gap channel 13 in the respective stator slot 7 extending in the axial direction with respect to the stator axis 3, through which a cooling medium, in particular oil, can flow along a slot cooling path 14 and which is formed in particular on both sides of the conductor 9 or conductor bundle 10. The stator slots 7 each extend in the radial direction with respect to the stator axis 3 between a slot base 7g and a slot slit 7s. The slot slits 7s of the stator slots 7 are closed by a sleeve-shaped slot closure, which abuts against circumferential sides of the stator teeth 6 facing the air gap and is referred to as a stator sealing sleeve 15 in the following. The stator sealing sleeve 15 has radial projections 16 on an outer side facing the stator laminated core 5, which extend in the radial direction into the slot slits 7s and extend in the axial direction.

According to the invention, it is provided that the radial projections 16 of the stator sealing sleeve 15 are slot slit obstructions 16, which block or constrict the portions of the respective slot slit 7s for the slot cooling path 14, wherein a plurality of spaced apart slot slit obstructions 16 are formed in the axial direction with respect to the stator axis 3 on the stator sealing sleeve 15 per slot slit 7s of the stator 1, which extend in particular to the conductor 9 and the conductor bundle 10, In this case, a slot slit passage 17 for deflecting the slot cooling path 14 back towards the slot base 7g is formed between adjacent slot slit obstructions 16 of the same slot slit 7s. The slot slit obstructions 16 of the stator sealing sleeve 15 thus serve to guide the flow of the slot cooling path 14. In particular, a meandering path is provided for the slot cooling path 14.

A plurality of support points 18 spaced apart from one another in the axial direction with respect to the stator axis 3 are formed in each of the stator slots 7 to support the conductor 9 or conductor bundle 10 lying in the respective stator slot 7. Each slot gap path 14 is constricted at least at the support points 18. For this reason, a bypass 19 is provided at each of the support points 18 to guide the cooling medium past the respective constricted support point 18. The bypasses 19 of the respective stator slot 7 are formed alternately at the slot base 7g or in the slot slit 7s to form the meandering slot cooling path 14 along the axial extension of the respective stator slot 7 wherein the bypass 19 is formed in the slot slit 7s as a slot slit passage 17 on the stator sealing sleeve 15.

According to FIG. 1, the bypasses 19 are formed alternately at the slot base 7g or in the slot slit 7s, for example, from one of the support sites 18 to the next support site 18.

The support points 18 can, e.g., be formed by rotating at least two laminations 8 of the stator laminated core 5 about the stator axis 3 by a specific angular rotation.

The stator sealing sleeve 15 projects in the axial direction with sleeve end sections 15e beyond both end faces of the stator laminated core 5, wherein the wall thickness of the sleeves end sections 15e is larger than the minimum wall thickness in an intermediate section of the stator sealing sleeve 15 between the sleeves end sections 15e.

The electric machine 2 includes a stator space 25 for arranging and cooling the stator 1 and a rotor space 26 for arranging a rotor 27 of the electric machine. The stator sealing sleeve 15 is provided for sealing the rotor space 26 against the stator space 25. The electric machine 2 includes two bearing shields 28 for mounting the rotor 27. An annular collar 29 is attached to the respective bearing shield 28 or is formed integrally. A sleeve seal 30 is provided between the annular collar 27 of the respective bearing shield 28 and the respective sleeve end section 15e of the stator sealing sleeve 15.

A stator cooling chamber 31 receiving the respective winding head of the stator winding 11 is formed on each end face of the stator 1. Starting from one of the two stator cooling chambers 31, flow can pass through the stator slots 7 into the other stator cooling chamber 31 along the slot cooling paths 14.

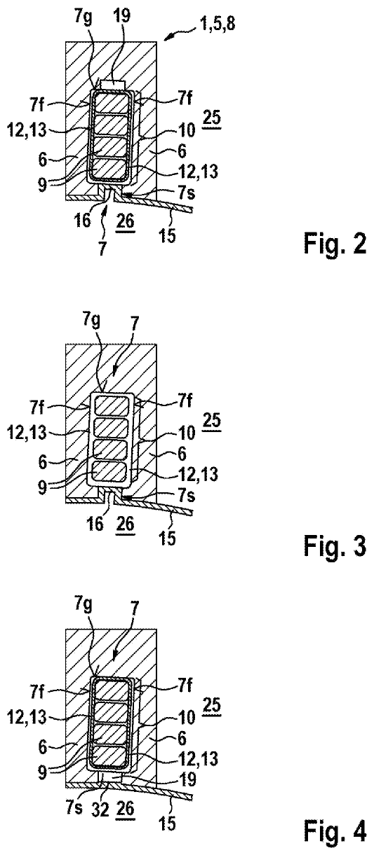

FIG. 2 shows a section through one of the stator slots of the stator along a line A-A in FIG. 1.

The slot slit obstructions 16 of the stator sealing sleeve 15 are bead-shaped according to the invention. The bead-shaped slot slit passages 17 of the stator sealing sleeve 15 can be designed as, for example, a bead interruption or a bead with reduced bead height.

The plurality of beads 16 per slot slit 7s are shorter in the axial direction than a core length of the stator laminated core 5 in each case in contrast to the stiffening ribs from the prior art.

The cut through the stator slot 7 of the stator 1 along line A-A is a cut through one of the support points 18. The bypass 19 for bypassing the support point 18 is provided in section according to FIG. 2 at the slot base 7g as a recess in the respective lamination 8. The bypass 19 lying on the slot base 7g can be formed in the slot base 7g, for example, or in the tooth flanks 7f at the foot of the stator teeth 6. In the slot slit 7s of the section according to FIG. 2, a bead-shaped slot slit obstruction 16 is provided. Support points 18 with a slot slit obstruction 16 thus have a bypass 19 in the slot base 7g.

FIG. 3 shows a section through one of the stator slots of the stator along a line B-B in FIG. 1.

The section through the stator slot 7 of the stator 1 along line B-B lies in the axial direction between two support points 18. Therefore, a bypass 19 is not provided at either the slot base 7g or the slot slit 7s. Thus, in the section according to FIG. 3, the stator sealing sleeve 15 comprises a bead-shaped slot slit obstruction 16.

FIG. 4 shows a section through one of the stator slots of the stator along a line C-C in FIG. 1.

The cut through the stator slot 7 of the stator 1 along line C-C is a cut through another of the support points 18. The bypass 19 for bypassing the support point 18 is provided in the section according to FIG. 4 in the slot slit 7s so that the stator sealing sleeve 15 has a slot slit passage 17 at this axial position. No bypass 19 is provided on the slot base 7f.

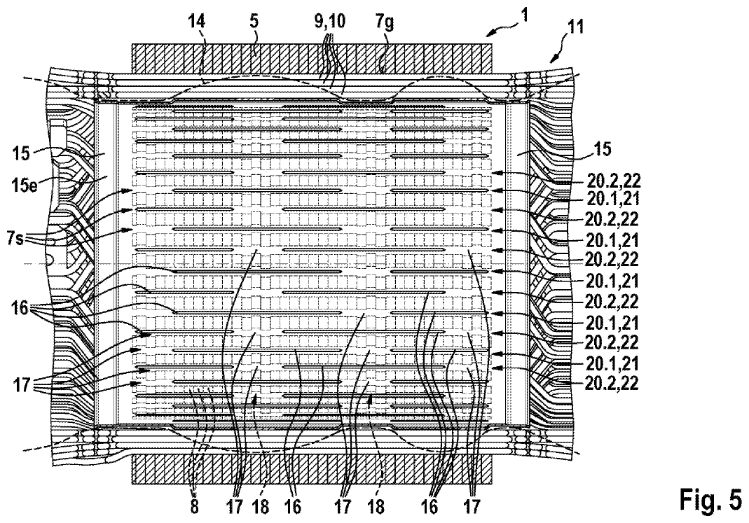

FIG. 5 shows a sectional view on an inner circumference of the stator according to FIG. 1 with the stator sealing sleeve according to the invention abutting the inner circumference.

The stator sealing sleeve 15 has an obstruction pattern 20 per slot slit 7s, comprising at least one slot slit obstruction 16 and at least one slot slit passage 17. For a first set 21 of slot slits 7s of the stator laminated core 5, a first obstruction pattern 20.1 is provided, and for a second set 22 of slotted slots 7s, a second locking pattern 20.2 is provided, wherein the second obstruction pattern 20.2 has a slot lit obstruction 16 at axial positions at which the first obstruction pattern 20.1 has a slot slit passage 17. The slot slit obstructions 16 of both obstruction patterns 20.1.20.2 may overlap, for example, when viewed in the axial direction. The first set 21 of slot slits 7s and the second set 22 of slot slits 7s comprise the same number of slot slits 7s.

According to the invention, the stator sealing sleeve 15 is manufactured by forming, in particular hot working, and is thereby rigidly connected to the stator laminated core 5, for example non-destructively non-detachably connected, in particular by displacing material of the stator sealing sleeve 15 according to FIG. 4 into the slot slits 7s. In this case, rib-shaped wall thickness thickening 32 is created in the slot slits 7s.

For example, the stator sealing sleeve 15 is made of a material comprising a thermoplastic, in particular a thermoplastic composite, specifically in particular a fiber-reinforced composite.

The stator sealing sleeve 15 is manufactured from a blank to be formed, which according to an exemplary first variant may be a smooth tube, which is mounted to the stator laminated core 5 with joining air and subsequently expanded. For example, the smooth tube may be an extruded tube or extruded sleeve. According to an exemplary second variant, the blank can be a strip of flat material which is formed on the circumferential sides of the stator teeth 6 facing the air gap to achieve the sleeve shape, in particular with overlapping of the two ends of the strip of flat material, and which is formed into the slot slits 7s of the stator laminated core 5 in the area of the slot slits 7s, in particular by roller burnishing. The strip of flat material can be a so-called organic sheet, for example.

The following steps are provided for the formation of the stator sealing sleeve 15 on the stator 1:

In a first step, a finished stator comprising a stator laminated core 5 and a stator winding 11 arranged in the stator laminated core 5 is provided.

In a subsequent second step, the blank for generating the stator sealing sleeve 15 is arranged along circumferential sides of the stator teeth 6 of the stator laminated core 5 facing the air gap.

In a further third step, the blank is formed, in particular hot-formed, for example by rolling a strip of flat material or expanding a smooth tube. Forming is carried out by means of at least one forming tool such that the blank abuts the circumferential sides of the stator teeth 6 facing the air gap, in particular such that the material of the blank according to FIG. 4 is displaced into the slot slits 7s. In this case, rib-shaped wall thickness thickening 32 is created in the slot slits 7s. In addition, beads are created in the static sealing sleeve 15 to form the slot slit obstructions 16, wherein the beads can be produced in a separate step or already in the previously described forming of the blank. During beading, indentations are created at the circumference of the stator sealing sleeve 15, as can be seen in FIG. 2 and FIG. 3.

For hot working, the forming tool and/or the blank may be heated up before forming.

1. A stator (1) of an electric machine (2) having a stator axis (3) and a stator laminated core (5) on which stator teeth (6) and stator slots (7) lying between the stator teeth (6) are formed and which comprises a plurality of laminations (8), wherein a conductor bundle (10), comprising an individual conductor (9) or multiple conductors (9), is provided to form an electric stator winding (11) in the stator slots (7), wherein slot gaps (12) are formed between flanks (7f) of the respective stator slot (7) and the conductor bundle (10) arranged in the stator slot (7), which form a slot gap channel (13) extending in an axial direction with respect to the stator axis (3) in the respective stator slot (7), through which slot gap channel a cooling medium can flow along a slot cooling path (14), wherein the stator slots (7) each extend in a radial direction with respect to the stator axis (3) between a slot base (7g) and a slot slit (7s), wherein the slot slits (7s) of the stator slots (7) are closed by a slot closure formed as a stator sealing sleeve (15), wherein the stator sealing sleeve (15) comprises radial projections (16) on an outer side facing away from the stator laminated core (5) extending in the radial direction in the slot slit (7s) and extend in the axial direction, wherein
the radial projections (16) of the stator sealing sleeve (15) are slot slit obstructions that block or constrict portions of the respective slot slit (7s) for the slot cooling path (14),
a plurality of spaced apart slot slit obstructions (16) are formed in the axial direction on the stator sealing sleeve (15) per slot slit (7s) of the stator (1),
a slot slit passage (17) for deflecting the slot cooling path (14) is formed between adjacent slot slit obstructions (16) of the same slot slit (7s), and
the slot slit obstructions (16) of the stator sealing sleeve (15) are bead-shaped.

2. The stator according to claim 1, wherein the slot slit passages (17) of the stator sealing sleeve (15) are formed as bead interruptions or as beads with reduced bead height.

3. The stator according to claim 1, wherein the stator sealing sleeve (15) per slot slit (7s) has an obstruction pattern (20) comprising at least one slot slit obstruction (16) and at least one slot slit passage (17), wherein a first obstruction pattern (20.1) is provided for a first set (21) of slot slits (7s) and a second obstruction pattern (20.2) is provided for a second set (22) of slot slits (7s), wherein the second obstruction pattern (20.2) has a slot slit obstruction (16) at axial positions, on which the first obstruction pattern (20.1) comprises a slot slit passage (17), wherein the slot slit obstructions (16) of both obstruction patterns (20.1,20.2) overlap.

4. The stator according to claim 1, wherein a plurality of support points (18) spaced apart from one another in the axial direction with respect to the stator axis (3) are formed in each of the stator slots (7) to support the conductor bundle (10) lying in the respective stator slot (7), wherein the respective slot cooling path (14) is at least constricted at the support points (18), wherein a bypass (19) is provided at each of the support points (18) to guide the cooling medium past the respective constricted support point (18), wherein the bypasses (19) of the respective stator slot (7) for forming a meandering slot cooling path (14) along an axial extension of the respective stator slot (7) are formed alternately at the slot base (7g) or in the slot slit (7s), wherein the bypass (19) in the slot slit (7s) is provided as the slot slit passage (17) on the stator sealing sleeve (15).

5. The stator according to claim 4, wherein the support points (18) are formed by rotating at least two laminations (8) of the stator laminated core (5) about the stator axis (3) by a predetermined angular rotation.

6. The stator according to claim 1, wherein the stator sealing sleeve (15) is fixedly connected to the stator (1) by forming material of the stator sealing sleeve (15) into the slot slits (7s).

7. The stator according to claim 1, wherein the stator sealing sleeve (15) is made of a material comprising a thermoplastic.

8. The stator according to claim 1, wherein the stator sealing sleeve (15) is made of a blank to be formed, wherein the blank is
a. a smooth tube, which is mounted to the stator laminated core (5) with joining air and subsequently expanded, or
b. a strip of flat material, which is formed on circumferential sides of the stator teeth (6) facing an air gap to achieve the sleeve shape and is formed into the slot slits (7s) of the stator laminated core (5), in the area of the slot slits (7s).

9. A method for forming a stator sealing sleeve (15) on a stator (1) according to claim 1, comprising the steps of:
a. providing a finished stator (1) comprising a stator laminated core (5) and a stator winding (11),
b. arranging a blank for generating a stator sealing sleeve (15) along circumferential sides of the stator teeth (6) of the stator laminated core (5) facing an air gap,
c. generating the stator sealing sleeve (15) by forming of the blank by at least one forming tool such that the blank lies against the circumferential sides of the stator teeth (6) facing the air gap, and
d. generating beads in the stator sealing sleeve (15) to form the slot slit obstructions (16).

10. An electric machine with a stator according to claim

11. The stator according to claim 1, wherein the multiple conductors (9) include a stack of flat wire conductors.

12. The stator according to claim 1, wherein the cooling medium is oil.

13. The stator according to claim 1, wherein the plurality of spaced apart slot slit obstructions (16) extend to the conductor bundle (10).

14. The stator according to claim 3, wherein the slot slit obstructions (16) of both obstruction patterns (20.1,20.2) overlap when viewed in the axial direction.

15. The stator according to claim 7, wherein the stator sealing sleeve (15) is made of a material comprising a thermoplastic composite or a fiber reinforced thermoplastic composite.

16. The stator according to claim 8, wherein the blank is a smooth tube formed by an extruded sleeve.

17. The stator according to claim 8, wherein the blank is a strip of flat material formed from an organic sheet.

18. The stator according to claim 8, wherein the blank is a strip of flat material formed into the sleeve shape by overlapping two ends of the strip of flat material.

19. The stator according to claim 8, wherein the blank is a strip of flat material and is formed into the slot slits (7s) of the stator laminated core (5) in the area of the slot slits (7s) by rolling burnishing.
